(19) United States
(12) Patent Application Publication
(10) Pub. No.: US 2014/0174304 A1
(43) Pub. Date: Jun. 26, 2014

(54) BALER UNLOADING RAMP RETURN MECHANISM

(71) Applicant: AGCO Corporation, Duluth, GA (US)

(72) Inventors: Cedric J. Blough, Moundridge, KS (US); Cole R. Schmidt, Newton, KS (US)

(73) Assignee: AGCO Corporation, Duluth, GA (US)

(21) Appl. No.: 14/089,831

(22) Filed: Nov. 26, 2013

Related U.S. Application Data
(60) Provisional application No. 61/730,396, filed on Nov. 27, 2012.

(51) Int. Cl. A01F 15/08

(52) U.S. Cl. CPC A01F 15/0883
USPC 100/76

(57) ABSTRACT

A round baler having a mobile chassis, a bale-forming chamber supported on the chassis and including a tailgate that can be raised for discharging a bale from the chamber and a bale discharge ramp. A combination pivot and spring assembly attaches the ramp to the chassis below the chamber for movement of the ramp from a raised, standby position to a lowered, unloading position for guiding a bale down to the ground as the bale leaves the chamber. The combination pivot and spring assembly includes an internal spring for yieldably maintaining the ramp in its raised position until a bale exiting the chamber engages the ramp and overcomes the force of the spring to swing the ramp down to its lowered position.

### CROSS REFERENCE TO RELATED APPLICATION

This application claims the benefit of U.S. Provisional Application No. 61/730,396, entitled BALER UNLOADING RAMP RETURN MECHANISM filed Nov. 27, 2012, which is hereby incorporated by reference in its entirety.

### BACKGROUND OF THE INVENTION

1. Field of Invention

This invention relates to the field of round balers and, more particularly, to a passive, spring-loaded bale discharge ramp for such machines.

2. Description of Related Art

Passive unloading ramps for guiding bales to the ground as they leave the baling chamber have been known and used for many years on round balers. Such ramps are spring-biased to a raised, standby position during normal baling operations but are forced down into a lowered, deployed position by the weight of the bale as it discharges from the baling chamber. The spring returns the ramp to its raised position once the bale rolls off the ramp.

Conventional designs utilize exposed compression or extension springs as the return mechanism for the ramp. However, such arrangements are highly susceptible to the accumulation of crop residue and dirt that fill up and clog the springs. Additionally, the pivots for the ramps are typically metal on metal and can be noisy or bind up. Lubrication added to the pivots has a tendency to attract and retain even more dirt and residue, which causes the pivots to bind up, work hard, and wear prematurely. Furthermore, assembly of the spring and pivot mechanism can be difficult.

### OVERVIEW OF THE INVENTION

The present invention provides a combination pivot and internal spring assembly for the ramp wherein the spring is housed protectively inside the pivot mechanism. Thus, the spring components are not exposed to the deleterious effects of the elements and do not collect trash and dirt. Furthermore, the spring components are so positioned that they help seal off and close opposite, otherwise open ends of a tubular member of the pivot to resist the ingress of harmful trash and dirt, as well as moisture, into the interior of the pivot. Moreover, the spring components support the rotatable part of the pivot in such a manner that no bearings are needed and there is no metal-to-metal contact of any kind within the pivot. In one preferred embodiment of the invention resilient rubber-like or elastomeric spring pads within the tubular outer member of the pivot assembly are compressed when the outer member is rotated relative to a stationary inner member as a discharging bale swings the ramp down to the ground, thereby torsionally loading the pivot assembly to effect automatic return of the ramp to its raised position once the bale rolls off the ramp.

In one embodiment, the invention is directed to a round baler having a mobile chassis, a bale-forming chamber supported on the chassis and including a tailgate that can be raised for discharging a bale from the chamber and a bale discharge ramp. A combination pivot and spring assembly attaches the ramp to the chassis below the chamber for movement of the ramp from a raised, standby position to a lowered, unloading position for guiding a bale down to the ground as the bale leaves the chamber. The combination pivot and spring assembly includes an internal spring for yieldably maintaining the ramp in its raised position until a bale exiting the chamber engages the ramp and overcomes the force of the spring to swing the ramp down to its lowered position. In one embodiment, the combination pivot and spring assembly further include a stationary member fixed to the chassis and a rotatable member fixed to the ramp for rotational movement relative to the stationary member when the ramp moves between the raised and lowered positions, and the spring is operatively disposed between the members.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a left side elevational view of a round baler incorporating a spring-loaded, passive unloading ramp in accordance with the principles of the present invention, the ramp being shown in the raised position;

FIG. 2 is a left side elevational view similar to FIG. 1 but showing the tailgate raised and the ramp forced down to its lowered position by a discharging bale;

FIG. 3 is a left, rear isometric view of the baler with the tailgate closed and the ramp in the raised position corresponding to FIG. 1;

FIG. 4 is a left, rear isometric view of the baler with the tailgate raised and the ramp in the lowered position corresponding to FIG. 2;

FIG. 5 is an enlarged, fragmentary, left rear isometric view of the ramp in the raised position with parts broken away to review details of construction;

FIG. 6 is an enlarged, fragmentary, right, rear, bottom isometric view of the ramp in the raised position;

FIG. 7 is an enlarged, left rear isometric view of the ramp and its associated pivot assembly;

FIG. 8 is an enlarged, left, front, bottom isometric view of the ramp and its associated pivot assembly;

FIG. 9 is an enlarged, fragmentary top plan view of the left end of the ramp and associated pivot assembly with parts broken away to reveal details of construction;

FIG. 10 is an enlarged, fragmentary cross-sectional view through the ramp and associated pivot assembly illustrating the condition of things when the ramp is in its raised position;

FIG. 11 is a view of the ramp and associated pivot assembly similar to FIG. 10 but showing the condition of things when the ramp is in the lowered position; and

FIG. 12 is an exploded, left front isometric view of the ramp and associated pivot assembly.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

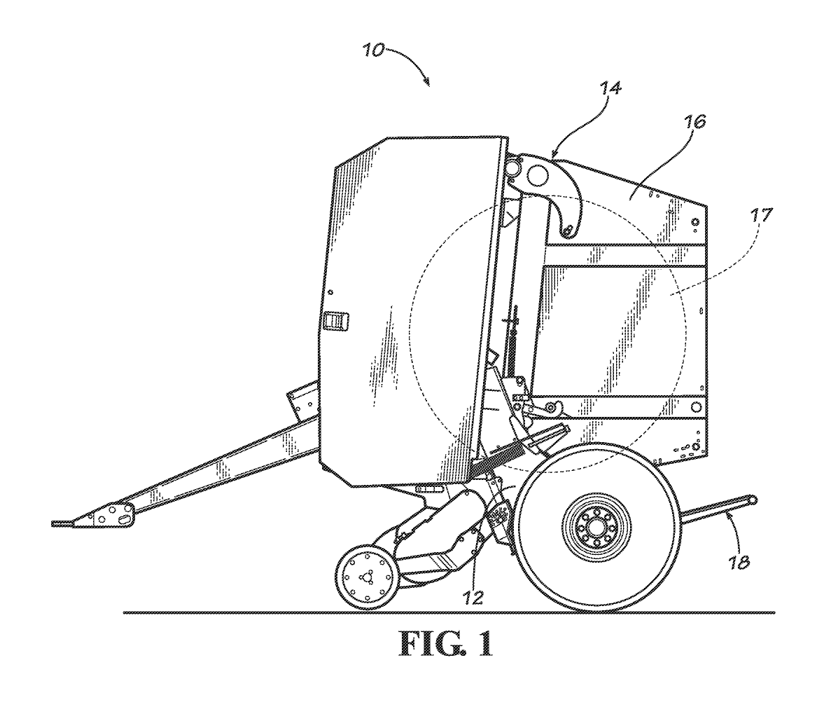

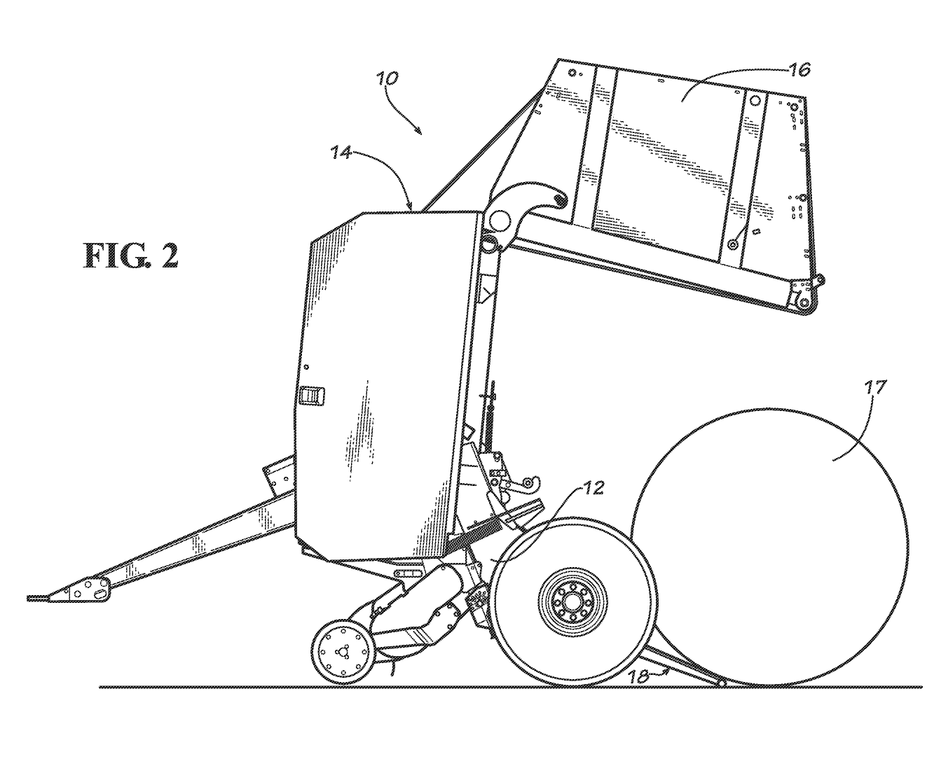

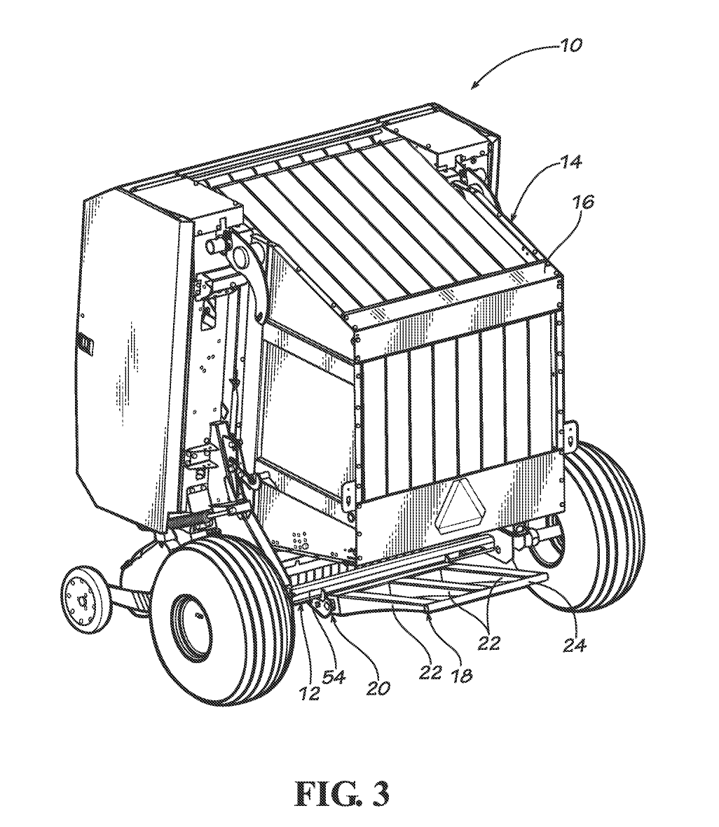

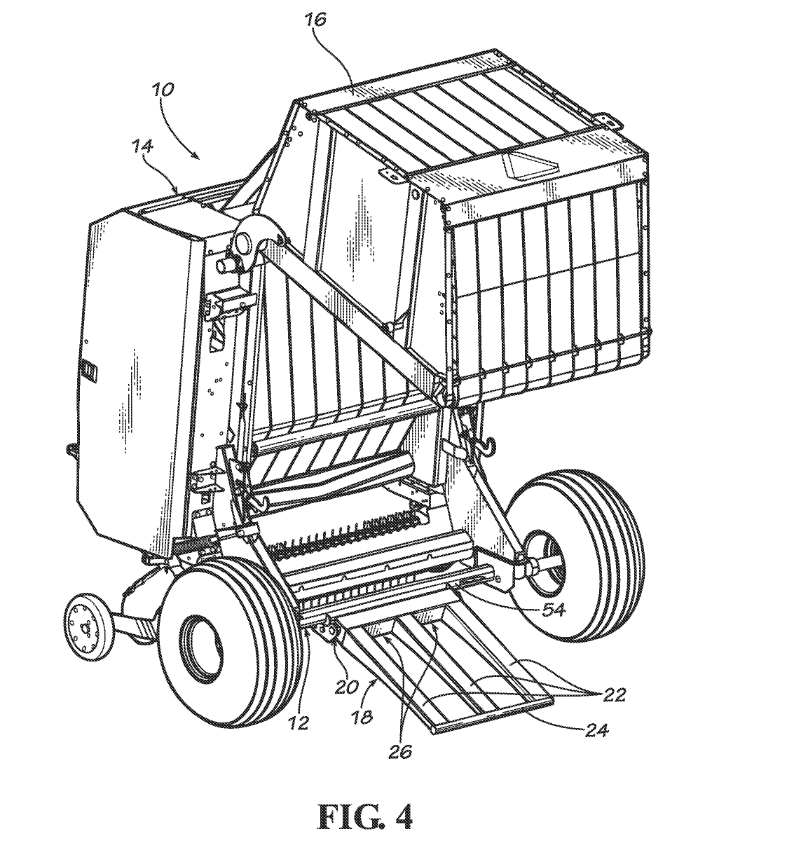

A round baler 10 has a wheeled mobile chassis 12 that supports a baling chamber 14 for forming a round bale from crop materials picked up from a field as the baler is towed across the field. At the completion of a bale-forming cycle, a tailgate 16 that comprises the rear half of baling chamber 14 is raised to allow a finished bale 17 to roll out of the chamber by gravity and onto the ground. A passive, spring-loaded unloading ramp 18 is provided to guide bale 17 to the ground as it discharges from chamber 14. During baling operations, ramp 18 is disposed in a raised position as shown, for example, in FIGS. 1 and 3, but as bale 17 engages ramp 18 during discharge, the weight of the discharging bale forces ramp 18 down to a lowered position as shown, for example, in FIGS. 2 and 4 in which the rear end of ramp 18 engages the ground. After the bale has rolled off ramp 18, the ramp automatically returns by spring force to its raised position, and tailgate 16 is reclosed by the operator.

In accordance with the present invention, ramp 18 is attached to chassis 12 below baling chamber 14 by a combination pivot and spring assembly 20 wherein spring components of the assembly are internally disposed. Ramp 18 may be constructed in a number of different ways without departing from the principles of the present invention, but in the particular embodiment disclosed herein it comprises three fore-and-aft extending, laterally spaced apart and transversely U-shaped, inverted channels 22 that are interconnected across their rear ends by a common transverse pipe 24. At their front ends channels 22 are interconnected by a common, inverted L-shaped beam 26 having a vertical rear leg 28 and a horizontal top leg 30. Three pairs of generally C-shaped, upright mounting lugs 32 project forwardly from vertical leg 28 beneath horizontal leg 30 for use in attaching ramp 18 to combination pivot and spring assembly 20 as hereinafter described.

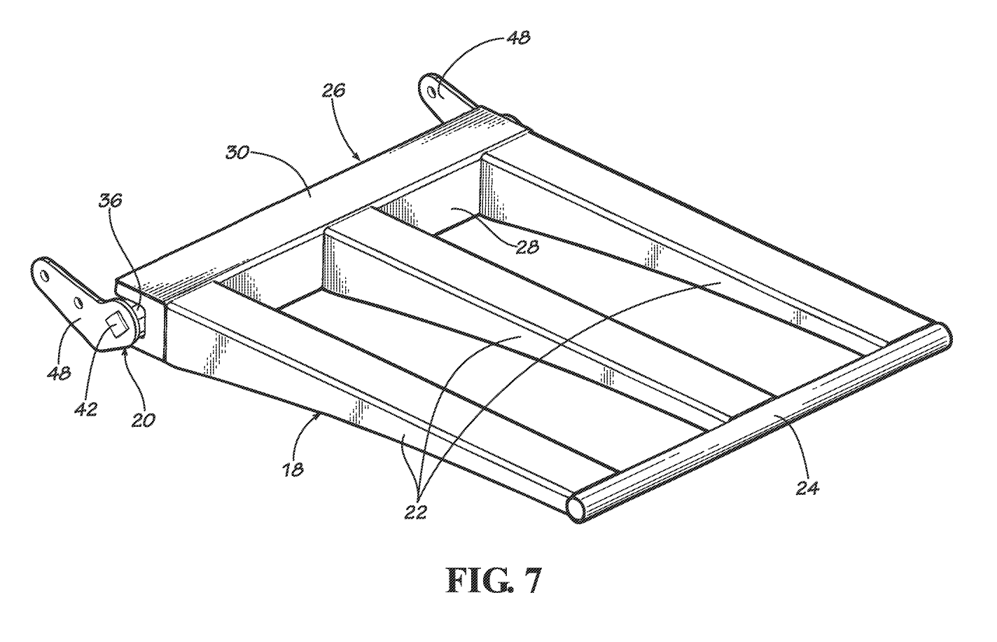

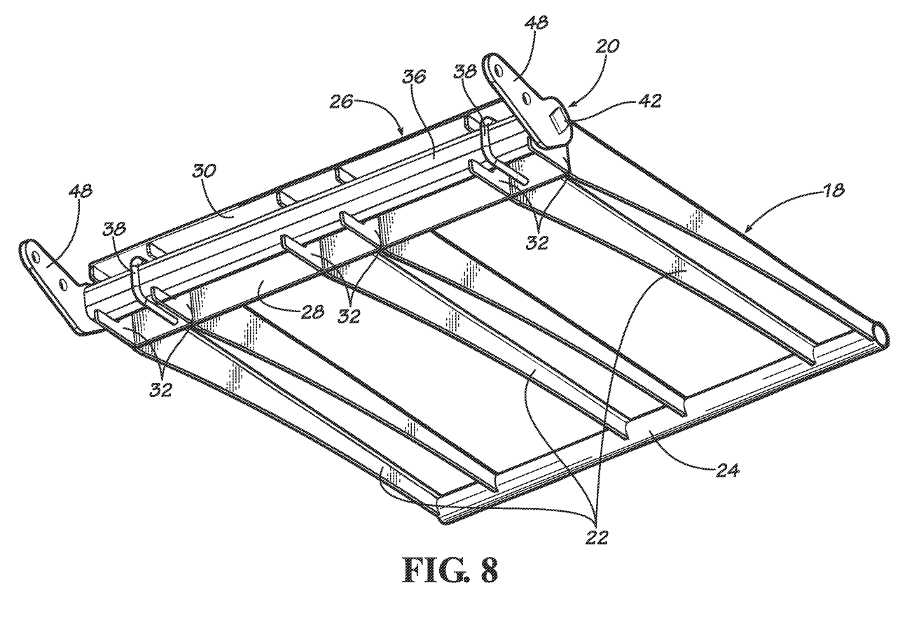

Combination pivot and spring assembly 20 includes a hollow outer pivot member, preferably in the form of an elongated tube 36, that rotates with ramp 18 during movement of the ramp between its raised and lowered positions. In the particular illustrated embodiment, tube 36 has a four-sided, rectangular cross-sectional configuration, although it will be appreciated that tube 36 may have a lesser or greater number of sides and need not necessarily be polygonal in cross-section. Tube 36 extends parallel to beam 26 and is complementally received within the forwardly facing mouths of mounting lugs 32, while a pair of U-bolts 38 fixedly secure tube 36 and beam 26 together. Opposite ends of tube 36 project slightly outwardly beyond the outermost mounting lugs 32 as shown, for example, in FIGS. 7, 8 and 9.

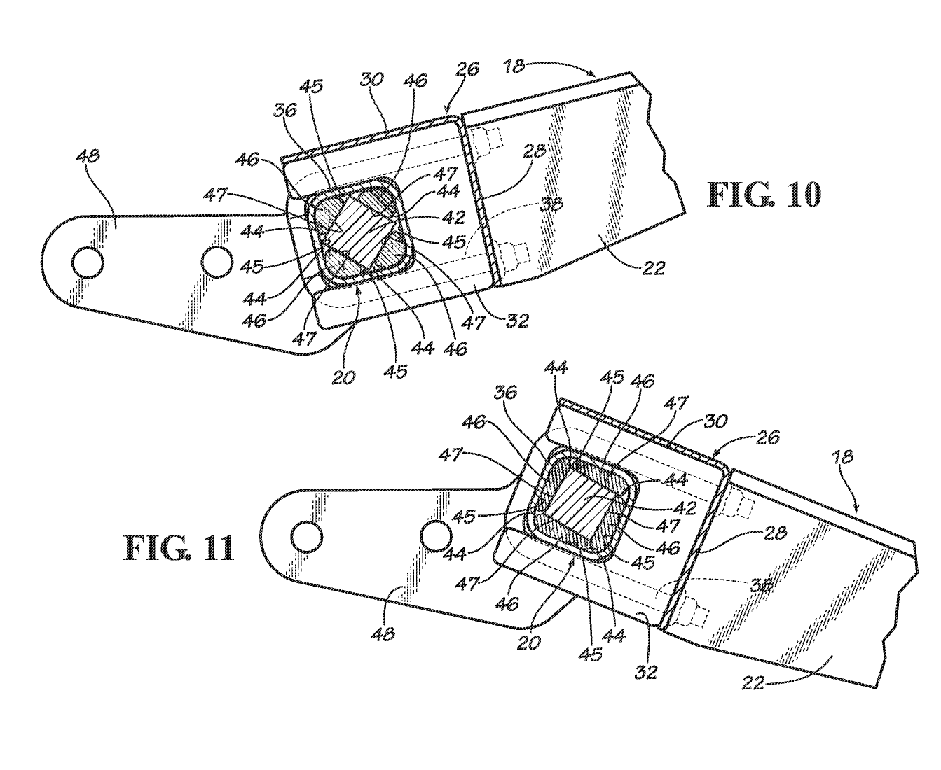

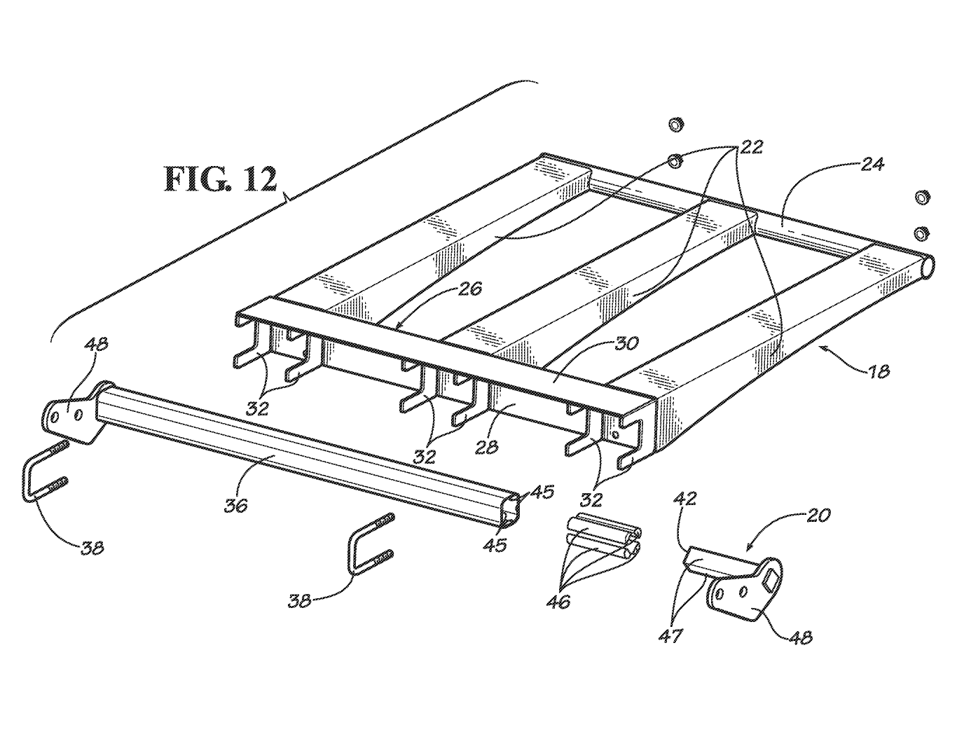

Combination pivot and spring assembly 20 further includes a stationary inner pivot member, preferably in the form of a pair of axially aligned, longitudinally spaced apart, rectangular stub shafts 42 that project into opposite ends of outer tube 36. Like tube 36, stub shafts 42 may each have fewer or greater than four sides and need not necessarily be polygonal in cross-section, although it is advantageous in any event for the sake of simplicity for stub shafts 42 to match the polygonal cross-sectional configuration of outer tube 36. Outer tube 36 has a somewhat larger cross-sectional configuration than stub shafts 42 and, in the illustrated embodiment, is rotatively offset by approximately 45 from stub shafts 42 when ramp 18 is in its raised position as illustrated, for example, in FIG. 10. Consequently, when ramp 18 is in its raised position, a number of generally triangular-shaped voids 44 (FIG. 10 are presented at the internal corners of tube 36 between flat internal surfaces 45 of tube 36 and opposing flat external surfaces 47 of stub shafts 42 (see also FIG. 12.

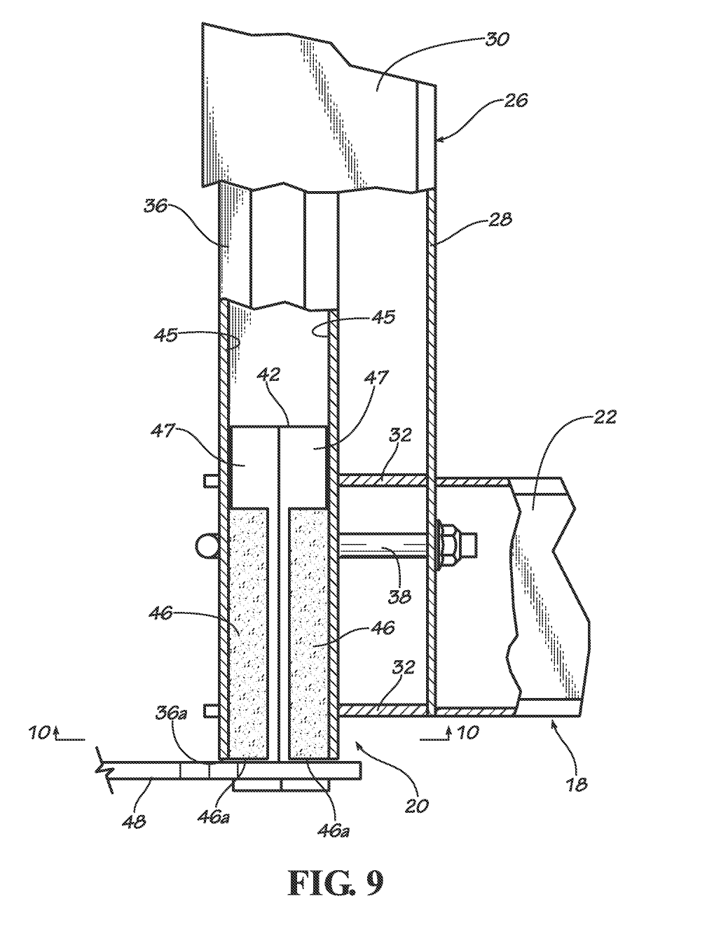

An internal spring is provided within tube 36 to interact with tube 36 and stub shafts 42 to form another part of combination pivot and spring assembly 20. Such internal spring preferably comprises a plurality of resilient, rubber, rubber-like, or elastomeric spring pads or “cords” 46 that occupy the voids 44. Preferably, the pads 46 are each generally triangular in cross-sectional configuration to match the triangular shape of voids 44, although other cross-sectional shapes may also be acceptable. As will be seen, the closer the pads 46 match the shape of the voids 44, the more completely stub shafts 42 and pads 46 will serve to plug and close the otherwise open ends of tube 36. As illustrated in FIG. 9, pads 46 have outermost ends 46a that are substantially flush with the corresponding end edges 36a of tube 36 at its opposite ends.

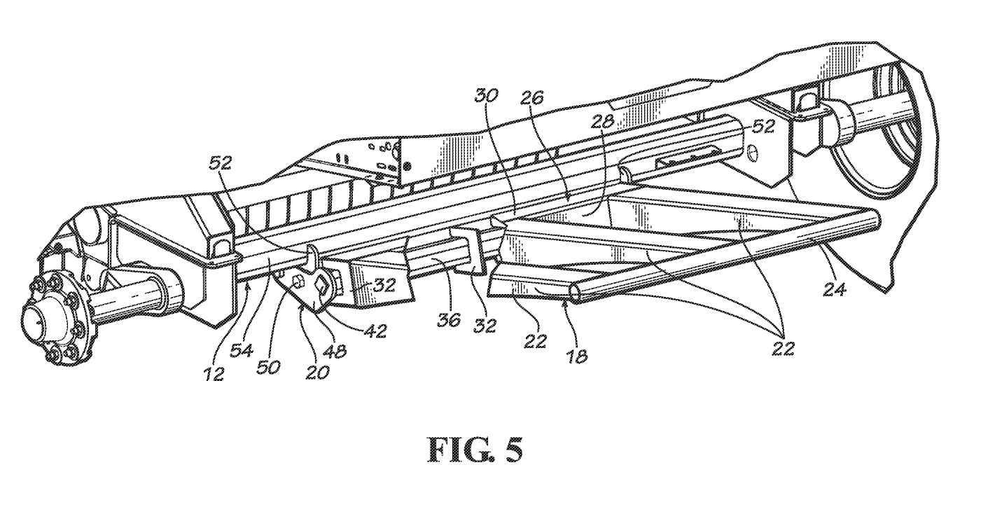

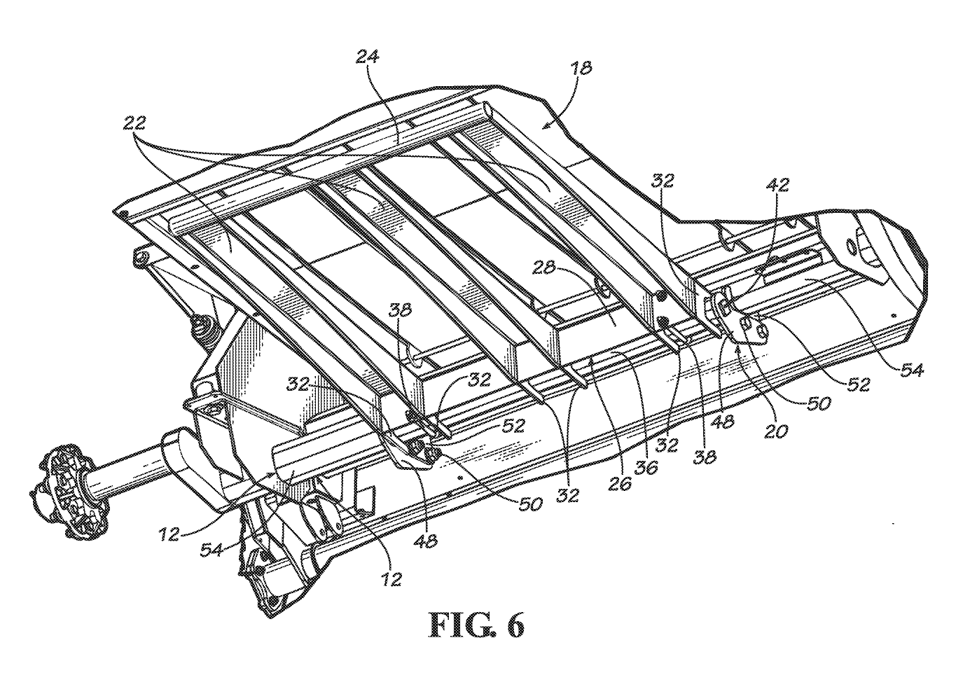

Combination pivot and spring assembly 20 additionally includes a pair of fore-and-aft mounting arms 48 fixed to and projecting forwardly from the outer ends of stub shafts 42. Mounting arms 48 are spaced a short distance outwardly from the opposite end edges 36a (see FIG. 9 so as to avoid metal-to-metal contact between arms 48 and tube 36 as ramp 18 pivots about the common longitudinal axis of stub shafts 42 and tube 36 during movement between its raised and lowered positions. Mounting arms 48 are, in turn, rigidly attached by bolts 50 (FIGS. 5, 6 to a corresponding pair of generally U-shaped brackets 52 that are affixed by welding or the like to a fixed, transverse axle tube 54 forming part of chassis 12.

It should be apparent from the foregoing description that ramp 18 and outer tube 36 pivot about stub shafts 42 during movement between the raised and lowered positions as stub shafts 42 remain stationary. Spring pads 46, operating against flat surfaces 45 and 47 of tube 36 and stub shafts 42 respectively, yieldably bias ramp 18 toward its raised position and maintain it in such position throughout baling operations. However, when a bale ejects from chamber 14 and engages ramp 18, the weight of the bale causes ramp 18 and outer tube 34 to rotate downwardly about stub shafts 42 (FIG. 11, causing flat surfaces 45 of tube 36 to move in such a direction relative to flat surfaces 47 of stub shafts 42 that spring pads 46 are rolled and significantly compressed. The spring rate of pads 46 is such that they cannot prevent the bale from pushing ramp 18 all the way down to the ground, but once the bale has reached the ground and rolled away from the ramp, the pads 46 overcome the weight of the ramp alone and return it to the raised position as they seek to restore themselves to their less stressed condition.

Having the spring components for ramp 18 housed internally within the pivot structure for the ramp provides several important benefits. For one thing, it provides a simple, clean and uncluttered design for the ramp. For another, it protects the spring components from the harmful effects of the elements and keeps them free of dirt and residue to avoid the problem of trash accumulation on prior exposed compaction and extension springs. In this respect, having pads 46 essentially flush with the end edges 36a of tube 36, rather than recessed deeply within tube 36, helps keep materials and moisture from entering into tube 36 in significant amounts. Depending upon the cross-sectional shape selected for pads 46, the cross-section of tube 36 at end edges 36a may essentially completely close that region. Moreover, even though there are no bearings or lubricant as part of the pivot mechanism, there is still no harmful metal-to-metal contact of the component parts. The pads 46 effectively serve not only as return spring mechanism for the ramp, but also as a means of physically isolating the outer tube 36 from stub shafts 42 while allowing the pivoting action to take place.

One suitable commercially available product for use as the combination pivot and spring assembly 20 is a “Torflex” rubber torsion suspension axle product obtainable from Dexter Axle Company of Elkhart, Ind. Another suitable commercially available product may be obtained from Axis Products, Inc. of Elkhart, Ind. as part of their torsion spring product line.

In selecting the spring rate for the pads 46 that make up part of assembly 20, a number of factors are considered. The primary consideration is that the spring must be strong enough to support the weight of the ramp and minimize bouncing of the ramp while the baler travels over a rough field, yet not be so strong that the bale cannot deflect the ramp down to the ground when leaving the baler. If the spring is too strong, the bale will not be allowed to leave the baler. While in many crops this is not a problem because the bales have significant mass, in some crops such as wheat straw, the bales are not as heavy. Thus, the spring rate is selected to be such that the spring is strong enough to hold the ramp in the raised position with a minimal amount of bouncing, but not much stronger than that.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A round baler comprising:
a mobile chassis;
a bale-forming chamber supported on said chassis and including a tailgate that can be raised for discharging a bale from the chamber;
a bale discharge ramp; and
a combination pivot and spring assembly attaching the ramp to said chassis below the chamber for movement of the ramp from a raised, standby position to a lowered, unloading position for guiding a bale down to the ground as the bale leaves the chamber,
said combination pivot and spring assembly including an internal spring for yieldably maintaining the ramp in its raised position until a bale exiting the chamber engages the ramp and overcomes the force of the spring to swing the ramp down to its lowered position.

2. A baler as claimed in claim 1, wherein said combination pivot and spring assembly further include a stationary member fixed to the chassis and a rotatable member fixed to the ramp for rotational movement relative to said stationary member when the ramp moves between said raised and lowered positions, and said spring is operatively disposed between said members.

3. A baler as claimed in claim 2, wherein said rotatable member is hollow for housing both said stationary member and the spring.

4. A baler as claimed in claim 3, wherein said stationary member is elongated to present a longitudinal axis, and said rotatable member is rotatable about said longitudinal axis of the stationary member.

5. A baler as claimed in claim 4, wherein said members has a least a pair of spaced apart, mutually opposed surfaces that are relatively movable generally toward one another when the ramp is rotated toward said lowered position, and said spring comprises a resilient pad between said pair of opposing surfaces that is disposed to be resiliently compressed by said opposing surfaces when the ramp is rotated down to said lowered position by a discharging bale.

6. A baler as claimed in claim 5, wherein said stationary member is polygonal in cross-section, and said rotatable member has a larger polygonal cross-sectional configuration than said stationary member and being rotatively offset from said stationary member when the ramp is in its raised position to present voids between the members at internal corners of the rotatable member, each of said voids containing a resilient pad.

7. A baler as claimed in claim 6, wherein said pivot assembly further includes at opposite ends of said rotatable member a pair of laterally spaced apart mounting arms fixed to said chassis, and said mounting arms have a pair of said stationary members fixed thereto in axially aligned, mutually spaced apart, inwardly facing relationship to one another.

8. A baler as claimed in claim 7, wherein said rotatable member comprises a tube surrounding said stationary members, said tube having a pair of opposite, open end edges disposed inwardly adjacent but spaced from said mounting arms, and said resilient pads have outer ends that are disposed substantially flush with said open end edges of the tube, said resilient pads being configured to occupy the voids between said stationary members and the tube at said open end edges of the tube.
